(19) United States
(12) Patent Application Publication
(10) Pub. No.: US 2012/0002247 A1
(43) Pub. Date: Jan. 5, 2012

(54) IMAGE SCANNING APPARATUS AND CONTROL METHOD OF DOCUMENT SIZE DETECTION LIGHT SOURCE

(75) Inventors: Yusuke HASHIZUME, Chiba-ken (JP); Sueo UENO, Shizuoka-ken (JP); Katsuya NAGAMOCHI, Tokyo (JP); Hiroyuki SHIRAISHI, Shizuoka-ken (JP); Koji SHIMOKAWA, Shizuoka-ken (JP); Naoya KOSEKI, Shizuoka-ken (JP); Mitsuru HATANO, Kanagawa-ken (JP)

(73) Assignees: Toshiba Tec Kabushiki Kaisha, Tokyo (JP); Kabushiki Kaisha Toshiba, Tokyo (JP)

(21) Appl. No.: 13/175,028

(22) Filed: Jul. 1, 2011

Related U.S. Application Data
(60) Provisional application No. 61/361,353, filed on Jul. 2, 2010.

(51) Int. Cl. H04N 1/04

(52) U.S. Cl. 358/475; 358/483

(57) ABSTRACT

A first LED that is one of a plurality of LEDs arranged in the main scanning direction is turned on, and the presence of a document on a document table glass is determined by detection of reflected light from the document using a CCD sensor, and a second LED other than the first LED in addition to the first LED among the plurality of LEDs is turned on when it is determined that a document is placed on the document table glass, and the size of the document on the document table glass is determined based on a scanning result of the CCD sensor on the reflected light from the document caused by illumination from the first and the second LEDs and a detection result of a reflective photosensor.

### CROSS-REFERENCE TO RELATED APPLICATION(S)

This application is based upon and claims the benefit of priority from: U.S. provisional application 61/361353, filed on Jul. 2, 2010; the entire contents all of which are incorporated herein by reference.

### FIELD

Embodiments described herein relate generally to a technology for controlling power consumption in an image scanning apparatus.

### BACKGROUND

In the related art, a document size detection sensor is known which detects the size of a document placed on a document table glass in an image scanning apparatus. Plural sensors for detecting document size are generally provided in order to discriminate sheets of various sizes.

With regard to power control of such a document size detection sensor, a technology is known for turning off the power of the document size detection sensor when image scanning is performed in order to save energy.

In addition, a configuration is also disclosed in which the power of the document size detection sensor is turned on or off according to the opening and closing of a document pressing member for pressing a document placed on the document table glass.

However, in the technology of the related art described above, for example, when a user opens the document pressing member in order to place a document on the document table glass, the power of all document size detection sensors maintains an on-state while the document pressing member is opened.

Driving the power of the document size detection sensors as above has a problem in terms of energy saving.

### DESCRIPTION OF THE DRAWINGS

FIG. 1 is a cross-sectional diagram showing the overview of a configuration of an image processing apparatus.

FIG. 2 is a diagram for illustrating the arrangement of document size detection sensors in an image scanning section R of an image processing apparatus M according to the embodiment.

FIG. 3 is a diagram for illustrating the arrangement of the document size detection sensors in the image scanning section R of the image processing apparatus M according to the embodiment.

FIG. 4 is a diagram for illustrating the arrangement of the document size detection sensors in the image scanning section R of the image processing apparatus M according to the embodiment.

FIG. 5 is a block diagram of functions in the image processing apparatus M.

FIG. 6 is a flowchart for illustrating the flow of a process in the image processing apparatus M.

FIG. 7 is a diagram showing an output of a CCD when an LED 1 detects the presence of a document.

### DETAILED DESCRIPTION

Hereinafter, an embodiment will be described with reference to drawings.

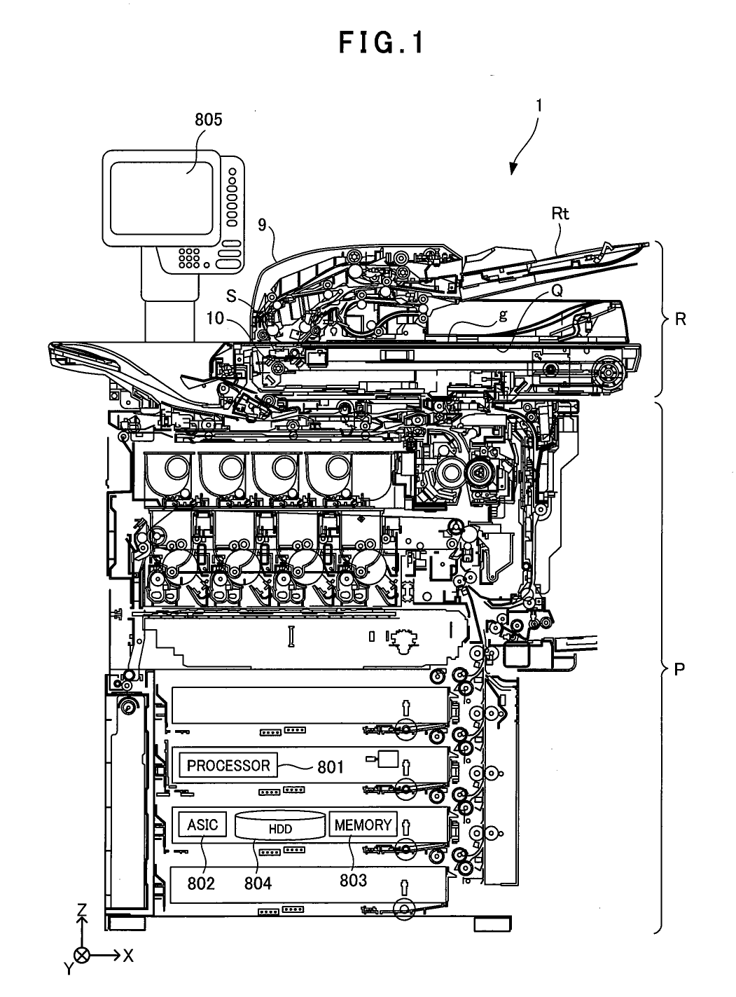

FIG. 1 is a cross-sectional diagram showing the overview of a configuration of an image processing apparatus (or MFP: Multi-Function Peripheral).

As shown in FIG. 1, the image processing apparatus according to the embodiment includes an image scanning section R and an image forming section P.

The image scanning section R has a function of scanning and reading images on a sheet document and a book document.

The image forming section P has a function of forming a developer image on a sheet based on the image read from the document in the image scanning section R, image data transmitted from an external device to the image processing apparatus, or the like.

The image scanning section R includes an automatic document feeder (ADF) 9 which enables automatic feeding of a document to a predetermined image scanning position, and a CCD sensor 10 scans a document placed on a document tray (a predetermined document placing table) Rt to which the automatic document feeder 9 automatically feeds the document or images of a document placed on a document table g.

In addition, the image processing apparatus according to the embodiment includes a processor 801, an ASIC (Application Specific Integrated Circuit) 802, a memory 803, and an HDD (Hard Disk Drive) 804 (refer to FIG. 1). The processor 801 is in charge of performing various processes in the image processing apparatus, and also of realizing various functions by executing a program stored in the memory 803. The memory 803 can be constituted by, for example, a RAM (Random Access Memory), a ROM (Read Only Memory), a DRAM (Dynamic Random Access Memory), an SRAM (Static Random Access Memory), a VRAM (Video RAM), or the like, and is in charge of storing various information and programs used in the image processing apparatus.

The processor 801 in an image processing apparatus M according to the embodiment is in charge of performing various processes in the image processing apparatus M, and also of realizing various functions by implementing programs stored in the memory 803, the HDD 804, and the like. Furthermore, it is needless to say that the processor 801 can be realized by a CPU (Central Processing Unit) or an MPU (Micro Processing Unit) that can execute equivalent arithmetic processes. In addition, the HDD 804 also can be substituted with a storage device, for example, a flash memory, or the like.

The memory 803 can be constituted by, for example, a RAM (Random Access Memory), a ROM (Read Only Memory), a DARM (Dynamic Random Access Memory), an SRAM (Static Random Access Memory), a VRAM (Video RAM), a flash memory, or the like, and is in charge of storing various information and programs used in the image processing apparatus M.

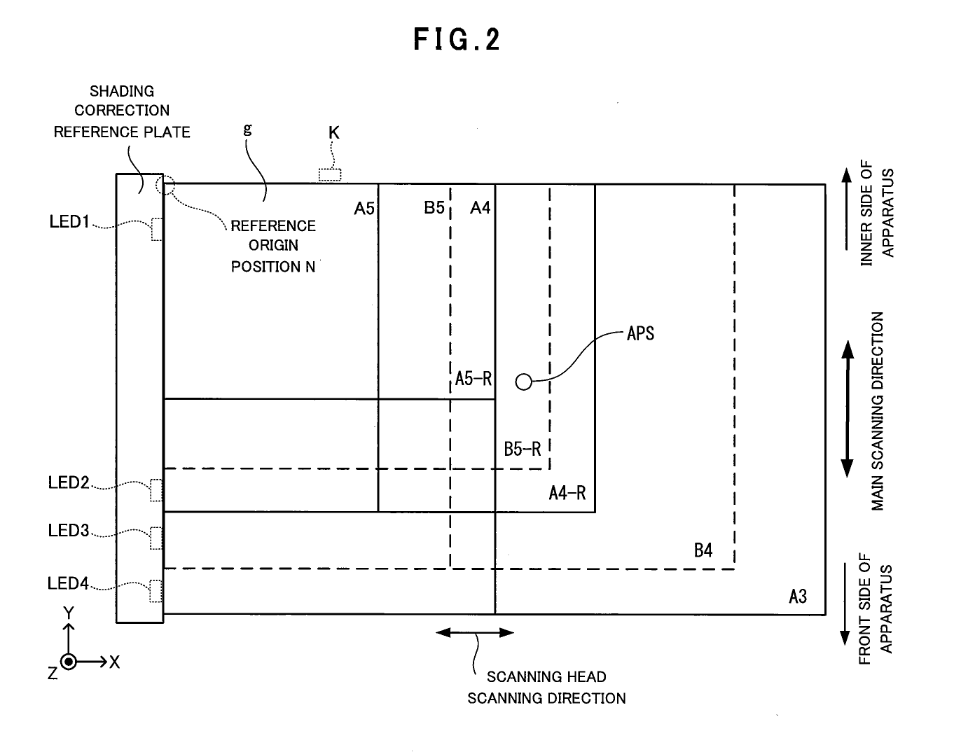

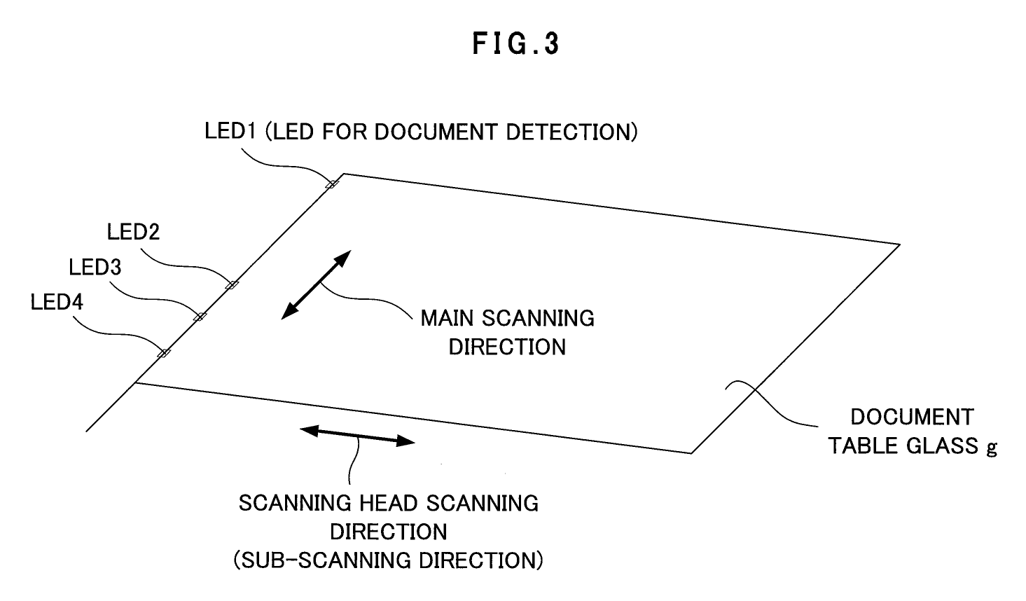

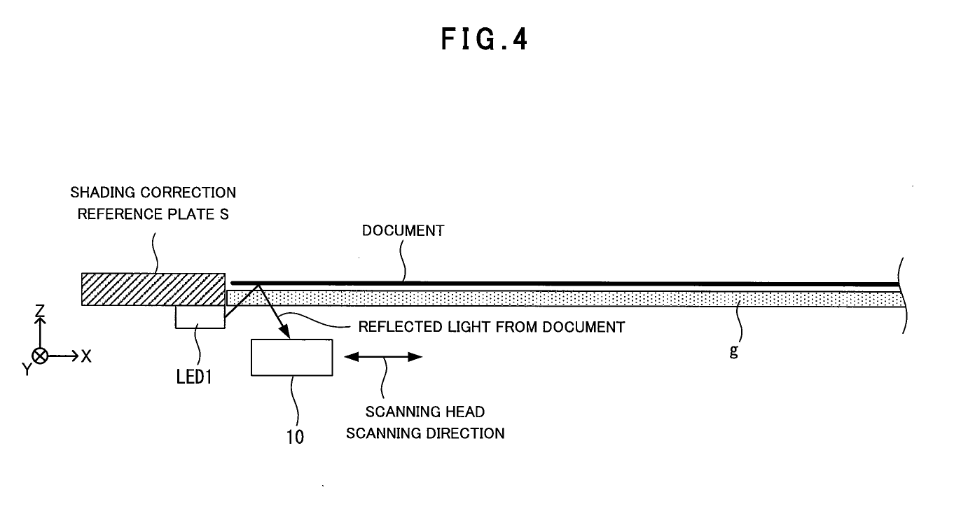

FIGS. 2 to 4 are diagrams for illustrating the arrangement of document size detection sensor group in the image scanning section R of the image processing apparatus M according to the embodiment. FIG. 2 is a plane view showing the appearance of the document table glass g seen from the above, and FIG. 3 is a perspective view schematically showing the arrangement of document size detection sensors on the document table glass. FIG. 4 is a diagram showing a positional relationship between a shading correction reference plate and the document table glass g and a document size detection LED.

The image scanning section R includes an LED 1, an LED 2, an LED 3, and LED 4 and a reflective photosensor APS as sensors for detecting the size of document placed on the document table glass g.

The LED 1, LED 2, LED 3, and LED 4 (refer to, for example, FIG. 2) are arranged below a shading correction reference plate S for performing shading correction in the image scanning apparatus R, and arranged in the main scanning direction.

A plurality of the LEDs 1 to 4 detect the size of a document placed on the document table glass g in the main scanning direction (direction in parallel with a Y axis). Thus, the plurality of LEDs 1 to 4 are arranged according to variations in the size of the sheet that is a size detection target. The variation in the size of the sheet herein means, for example, “A series” including A3, A4, A4-R, and the like, “LT series”, and the like.

The LED 1 (a first LED) is arranged furthest to the inside when seen from the front of the apparatus in the document table glass g among the plurality of LEDs 1 to 4.

Specifically, the LED 1 (the first LED) is arranged in the periphery of a reference origin position N for document contacting therewith on the document table glass g.

Illumination light from the LED 1 can be used not only in document detection but also as a distinguishing indicator for enhancing the visibility of the reference origin position N by arranging the LED 1 for document presence detection in the periphery of the reference origin position N that is located on the inner side of the apparatus and has poor visibility due to generally being in the shadow of a document pressing plate Q.

As such, the LED 1 for document presence detection (which is also used as a size detection LED) is arranged in a position where a document essentially contacts (a document contacting position on the inner side as viewed by a user when using a document contacting standard as in the embodiment).

The LED 1 for document detection is turned on at all times except when the image scanning section R executes an image scanning. By controlling the LED 1 to be turned on as above, the visibility of the document contacting position (the reference origin position N) in the state that the document pressing plate Q is open is enhanced, and miscopying, or the like can be reduced.

The reflective photosensor APS detects the size of a document placed on the document table glass g in the sub-scanning direction (direction parallel with an X axis). Furthermore, in the embodiment, one reflective photosensor APS is arranged, but it is not necessarily limited thereto, and a plurality of APSs may be arranged as needed.

The CCD sensor 10 senses reflected light from a document illuminated by the plurality of LEDs 1 to 4 (refer to, for example, FIG. 4).

An open-closed detection sensor K detects open and closed states of the document pressing plate Q which can be open and closed with regard to the document table glass g, and presses a document placed on the document table glass g.

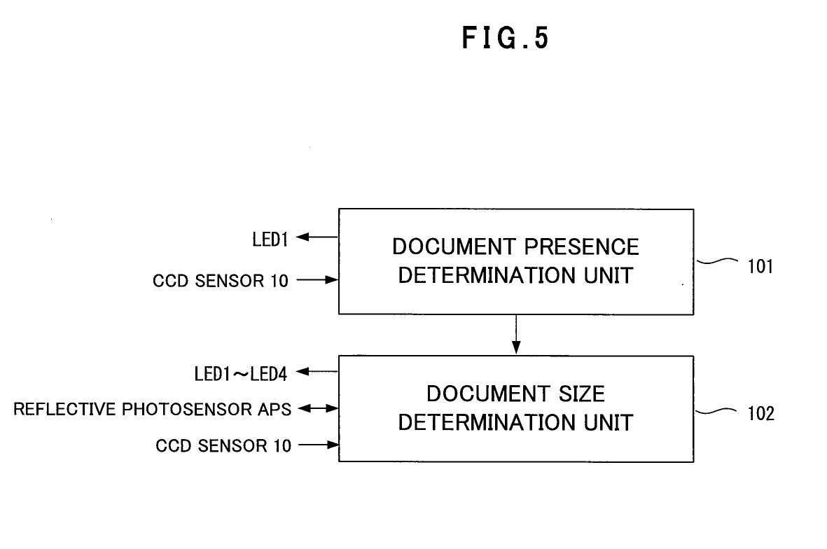

FIG. 5 is a block diagram of functions in the image processing apparatus M.

The image processing apparatus M includes a document presence determination unit 101 and a document size determination unit 102.

The document presence determination unit 101 causes the first LED (here, for example, the LED 1) that is one of the plurality of the LEDs 1 to 4 to be turned on, and determines the presence of a document on the document table glass g by detecting the presence of reflected light from the document using the CCD sensor 10.

When the document presence determination unit 101 determines that a document is placed on the document table glass g, the document size determination unit 102 causes a second LED other than the first LED (for example, the LED 2, the LED 3, and the LED 4 herein) to also be turned on in addition to the first LED among the plurality of the LEDs 1 to 4, and determines the size of the document on the document table glass g based on a scanning result by the CCD sensor 10 on the reflected light from the document caused by illumination from the first and the second LEDs (in other words, the LEDs 1 to 4) and a detection result of the reflective photosensor APS.

In addition, when the open-closed detection sensor K detects that the document pressing plate Q is open, the document presence determination unit 101 causes only the first LED to be turned on among the plurality of LEDs 1 to 4, and determines the presence of a document on the document table glass g based on a detection of the presence of reflected light from the document by the CCD sensor 10.

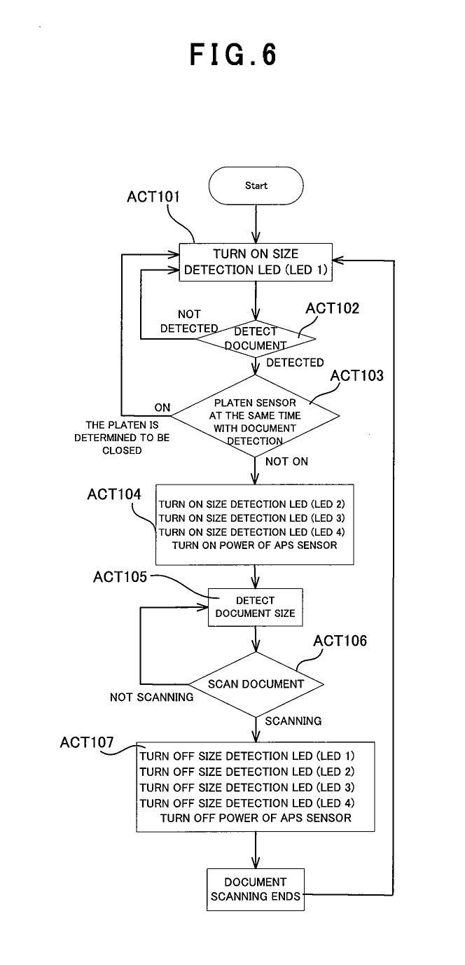

FIG. 6 is a flowchart for illustrating the flow of a process in the image processing apparatus M.

First, the processor 801 causes the LED 1 used as a light source for document presence detection to be turned on (ACT 101).

With a detection of reflected light from a document surface by the CCD sensor 10 resulting from a illumination light of the LED 1, the processor 801 determines that a document is placed at a position that the illumination light of the LED 1 reaches (ACT 102).

When it is determined that a document is placed as above, and the document pressing plate Q is closed (for example, in the state where the open-closed detection sensor K is on) (ACT 103, not on), the power of the LED 2, the LED 3, and the LED 4 which are used only for document size detection and the reflective photosensor APS is turned on while the LED 1 used as the light source for document presence detection is turned on (ACT 104).

The processor 801 causes the CCD sensor 10 to detect reflected light of the illumination light from the LEDs 1 to 4 on the document surface, and causes the reflective photosensor APS to perform document detection, whereby the size of the document placed on the document table glass g is determined.

It is possible to determine what size document is placed on the document table glass g based on a combination of detection results from each of the LED 1, the LED 2, the LED 3, the LED 4, and the reflective photosensor APS.

Then, when an image scanning is executed in the image scanning section R (ACT 106, scanning), the processor 801 turns off the power of the LEDs 1 to 4 and the reflective photosensor APS.

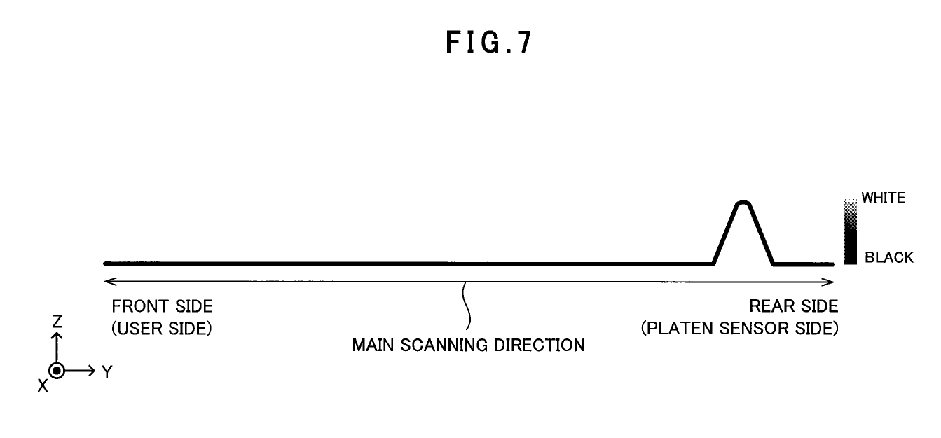

FIG. 7 is a diagram showing a CCD output (after A/D conversion in the main scanning direction) when the presence of a document is detected with the LED 1. When the CCD sensor 10 detects a document, light of the LED 1 is incident to the CCD sensor 10, and a level of white increases, whereby it is possible to determine that a document is placed.

Each function and operation for the above described processes in the image processing apparatus M are realized by the processor 801 executing programs stored in the memory 803.

In image scanning apparatuses of the related art, a plurality of reflective photosensors, or the like are arranged below an area of scanning target on a document table glass as sensors for document size detection. For that reason, the arrangement of those sensors occasionally restricted a design of the apparatus. However, in the image scanning apparatus according to the embodiment, it is possible to reduce the number of sensors to be arranged and used in determining the size of a document in the sub-scanning direction, which is efficient in terms of cost and the degree of freedom in design.

In addition, in the image scanning apparatuses of the related art, the power of all sensors used in document size detection is generally turned on at all times, which is problematic in terms of wasteful power consumption, however, in the image scanning apparatus according to the embodiment, the power to only the minimum sensors required is turned on during detection of the presence of a document, and the power of a plurality of light sources necessary for document size determination is turned on only when a specific document size is to be determined, whereby it is possible to achieve significant electricity savings in comparison to the above-described configuration of the related art.

Furthermore, it is possible to provide a program that executes the above-described each operation in a computer constituting the image processing apparatus M. The present embodiment exemplifies that such a program for realizing a function of implementing the exemplary embodiments is recorded in advance in a storage area provided inside the apparatus, but it is not limited thereto, and a similar program may be downloaded to the apparatus from a network, and a computer-readable recording medium storing a similar program may be installed in the apparatus. As a recording medium, any type of recording medium is possible if the medium can store programs and be readable by a computer. Specifically, as such a recording medium, for example, an internal storage device such as a ROM, or a RAM which is mounted in a computer, a portable recording medium such as a CD-ROM, a flexible disk, a DVD, a magneto-optical disc, or an IC card, a database which retains computer programs, other computers or a database thereof, a transmission medium on a communication circuit, or the like can be exemplified. In addition, a function obtaining from prior installation or downloading as above maybe realized in cooperation with an OS (operating system) in the apparatus, or the like.

Furthermore, part or all of a program may be a dynamically generated execution module.

In addition, it is needless to say that at least apart of various processes realized by executing a program by the processor 801 in the above-described embodiment can be implemented as a circuit in the ASIC 802.

As described above, it is possible to provide a power control technology for document size detection sensor, which contributes to energy saving, according to the technology described in the present specification.

While certain embodiments have been described, these embodiments have been presented byway of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. An image scanning apparatus, comprising:
a plurality of LEDs for detecting the size of a document placed on a document table glass in the main scanning direction;
a reflective photosensor for detecting the size of the document placed on the document table glass in the sub-scanning direction;
a CCD sensor which senses reflected light from the document illuminated by the plurality of LEDs;
a document presence determination unit which causes a first LED that is one of the plurality of LEDs to be turned on and determines the presence of a document on the document table glass with detection of the presence of the reflected light from the document by the CCD sensor; and
a document size determination unit which causes a second LED other than the first LED to be turned on in addition to the first LED among the plurality of LEDs when the document presence determination unit determines that a document is placed on the document table glass, and determines the size of the document on the document table glass based on a scanning result of the CCD sensor on the reflected light from the document caused by illumination from the first and the second LEDs and a detection result of the reflective photosensor.

2. The apparatus according to claim 1, wherein the first LED is arranged furthest to the inside of the document table glass when seen from the front of the apparatus among the plurality of LEDs.

3. The apparatus according to claim 1, wherein the first LED is arranged in the periphery of a reference origin position for document contacting therewith on the document table glass.

4. The apparatus according to claim 1, wherein the plurality of LEDs are arranged below a shading correction reference plate.

5. The apparatus according to claim 1, further comprising:
an open-closed detect ion sensor which detects open and closed states of a document pressing plate that can be open and closed for the document table glass, and presses a document placed on the document table glass,
wherein the document presence determination unit causes only the first LED to be turned on among the plurality of LEDs when the open-closed detection sensor detects an open state of the document pressing plate, and determines the presence of a document on the document table glass with detection of the presence of the reflected light from the document by the CCD sensor.

6. A control method of a document size detection light source in an image scanning apparatus including a plurality of LEDs for detecting the size of a document placed on a document table glass in the main scanning direction, a reflective photosensor for detecting the size of the document placed on the document table glass in the sub-scanning direction, and a CCD sensor which senses reflected light from the document illuminated by the plurality of LEDs, comprising:
causing a first LED that is one of the plurality of LEDs to be turned on and determines the presence of a document on the document table glass with detection of the presence of the reflected light from the document by the CCD sensor, and
causing a second LED other than the first LED to be turned on in addition to the first LED among the plurality of LEDs when it is determined that a document is placed on the document table glass, and determining the size of the document on the document table glass based on a scanning result of the CCD sensor on the reflected light from the document caused by illumination from the first and the second LEDs and a detection result of the reflective photosensor.

7. The method according to claim 6, wherein the first LED is arranged furthest to the inside of the document table glass when seen from the front of the apparatus among the plurality of LEDs.

8. The method according to claim 6, wherein the first LED is arranged in the periphery of a reference origin position for document contacting therewith on the document table glass.

9. The method according to claim 6, wherein the plurality of LEDs are arranged below a shading correction reference plate.

10. The method according to claim 6, further comprising:
an open-closed detection sensor which detects open and closed states of a document pressing plate that can be open and closed for the document table glass, and presses a document placed on the document table glass,
wherein only the first LED among the plurality of LEDs is turned on when the open-closed detection sensor detects an open state of the document pressing plate, and the presence of a document on the document table glass is determined with detection of the presence of the reflected light from the document by the CCD sensor.
